(19) United States
(12) Patent Application Publication
(10) Pub. No.: US 2015/0043243 A1
(43) Pub. Date: Feb. 12, 2015

(54) LIGHTING PANEL

(71) Applicant: DESIGN LED PRODUCTS LIMITED, West Lothian (GB)

(72) Inventor: James Gourlay, West Lothian (GB)

(21) Appl. No.: 14/382,014

(22) PCT Filed: Mar. 8, 2013
(86) PCT No.: PCT/GB2013/050584

§ 371 Date: Aug. 29, 2014

(30) Foreign Application Priority Data
Mar. 9, 2012 (GB) 1204167.9

(51) Int. Cl. F21V 8/00

(52) U.S. Cl. CPC G02B 6/0073; G02B 6/0053; G02B 6/0055
USPC 362/606; 29/841

(57) ABSTRACT

A lighting panel that provide an alternative means for producing a “spot light” like illumination from an LED is described. The lighting panel comprising a transparent substrate upon a first surface of which are mounted a plurality of transparent prism structures and upon a second surface of which is mounted a light emitting diode (LED). A transparent guide layer is arranged so as to encapsulate the light emitting diode upon the second surface such that the transparent base substrate and the transparent guide light form a composite structure for guiding light emitted from the LED. The transparent prism structures are configured to extract a first and a second light output from the lighting panel, the first and second light outputs having output angles and beam widths determined by the structure of the plurality of transparent prism structures. The lighting panels exhibit high optical efficiencies and long operating lifetimes.

The present invention relates to the field of lighting panels. In particular, a lighting panel device for illumination, lighting and display purposes is described that exhibits a light output having a definable narrow beam profile and definable beam angle.

Light Emitting Diodes (LEDs) are high efficacy and highly reliable examples of solid state light sources. As the cost benefits of solid state lighting improve, this technology is gradually replacing older lighting technologies, such as fluorescent lamps, in a wide variety of professional and consumer applications. LEDs are comparatively small sources of light and therefore generally employ external optics to provide a useful lighting system. It is important that the external optics, in conjunction with the performance specification of the LED, provides the desired function with a high optical efficiency. A high optical efficiency is needed so as to minimise cost (both unit and running), to minimise heat dissipation and to maximise energy efficiency credentials.

It is known to employ LEDs within a spot light type system so as to provide an output that exhibits a narrow profile and which has a definable beam angle. An example of such a system is presented schematically in FIG. 1, as represented generally by reference numeral 1. The LED spot light system 1 can be seen to comprise a cluster of LEDs 2 and a lens structure 3 arranged such that it lies between the cluster of LEDs 2 and an observer 4. Typically, the lens structure 3 is placed at some distance from the cluster of LEDs 2 so as to provide a means for collecting the light 5 from all of the LEDs in the cluster 2 and projecting this light forward in a narrow and well defined beam 6. The system is then orientated (or pointed) as a whole such that the narrow defined beam 6 is delivered to a desired location. A disadvantage of this described configuration is that such systems tend to be large, bulky system that exhibit depths of many centimetres.

Another more recent approach to LED lighting is to couple the LEDs to light-guide plates. This is used to give a thin luminaire panel with a large area of diffuse lighting. Examples of such devices are provided by the inventor within PCT Publication No. WO 2005/101070 and presented schematically in FIG. 2, as generally represented by reference numeral 7. Here a light source 8 is edge-coupled into a planar light guide 9. The light 10 generated by the light source 8 then propagates within the planar light-guide 9 due to the effects of total internal reflection. Extraction features 11 e.g. bumps, indents, grooves, ink dots or lines on the surface of the planar light guide 9 then enable the light 10 to escape the total internal reflection condition. A reflector 12 and diffuser 13 may also be incorporated so as to provide a means for further manipulating the light 10. The overall effect of this arrangement is that the planer light guide 9 transforms the point sources of light, namely the LEDs 8, into a diffuse area of illumination.

Commercially available examples of such systems may typically comprise 600 mm×600 mm sized panels that have LEDs located around the four edges of a sheet of a polymer light-guide plate. In practice it is found that as a result of the design of these systems the light output generated exhibits a very wide beam angle typically lambertian (120° Full Width Half Maximum). These systems are well suited for many applications however their designs do exhibit a number of limitations which makes them unsuitable for other types of applications.

In the first instance the optical coupling losses between the LEDs 8 and the light-guide edge, in combination with the large average optical path lengths of the light 10 within the absorbing transparent polymer of the panel 9, results in a system that exhibits significant optical loss. This optical loss impacts on the overall optical efficiency of the systems which is known to be as low as 50%.

The most common polymer material employed as the transparent light-guide plate 9 is acrylic (PMMA) due to this material having the highest optical transparency. However, compared with many other transparent materials (e.g. silicone), acrylic is not stable at high temperatures and high light power levels. Over time, the acrylic material is known to discolour and so light transmission is reduced. This is particularly evident in the areas closest to where the LEDs 8 are positioned, as they have the highest temperature and highest light power levels. These effects limit the working life-time of such products based on an acrylic light-guide. For lighting applications, where LEDs are promoted to have long life-times, this is a major disadvantage.

For applications where a particular beam angle distribution is required the wide, and usually lambertian, angular distribution of the output light provides further disadvantages. In such applications additional external films must be deployed, thus reducing further the optical efficiency, increasing production costs and providing general integration difficulties.

### SUMMARY OF INVENTION

It is therefore an object of an aspect of the present invention to obviate or at least mitigate the foregoing disadvantages of the LED based light source systems known in the art.

It is a further object of an embodiment of the present invention to provide an LED based lighting panel that exhibits an output having a narrow output beam profile.

A yet further aspect of an embodiment of the present invention is to provide an LED based lighting panel that exhibits a predetermined output beam angle.

In the following description the terms transparent refers to the optical properties of a component of the lighting panel at the wavelengths of the light generated by the LED light sources employed within the apparatus.

According to a first aspect of the present invention there is provided a lighting panel the lighting panel comprising a transparent substrate upon a first surface of which are mounted a plurality of transparent prism structures and upon a second surface of which is mounted a light emitting diode (LED), and a transparent guide layer, the guide layer being arranged so as to encapsulate the LED upon the second surface such that the transparent base substrate and the transparent guide light form a composite structure for guiding light emitted from the LED, wherein the plurality of transparent prism structures are configured to extract a first and a second light output from the lighting panel, the first and second light outputs having output angles and beam widths determined by the plurality of transparent prism structures.

The lighting panels effectively provide an alternative means for producing a “spot light” like illumination from an LED. Having the LED embedded within the devices also provides the added advantage of significantly improving the optical coupling of the light into the guide layer while allowing the overall thickness of the device to be reduced. Embedding the LED source also provides them with physical protection while allowing for improved thermal dissipation. The lighting panels therefore exhibit high optical efficiencies and long operating lifetimes.

The plurality of transparent prism structures extract the first and second light output from the lighting panel by disrupting internal reflection effects within the composite structure.

Preferably the first and second light outputs are extracted from opposite sides of the lighting panel.

Most preferably the plurality of transparent prism structures are configured to compress the light emitted from the LED. In this context compression means that the width of the first and second light outputs is narrower than the width of the light emitted from the LED.

Most preferably the lighting panel further comprise a transparent coating layer applied to the plurality of transparent prism structures wherein the transparent coating layer provides a further means for determining the output angles of the first and second light outputs.

Preferably the transparent coating is applied to the plurality of transparent prism structures so as to form a substantially planar surface. Having a substantially planar surface reduces the tendency for dirt or dust to settle on the exposed surface.

Optionally, the transparent coating comprises a spatial pattern e.g. lined or chequered patterns. The spatial pattern acts to providing two components to both the first and second output beams. The resulting light intensity distribution is therefore a superposition of these two components of the first and second output beams.

Optionally the lighting panel further comprises a reflector arranged so as to reflect the first light output back through the composite structure. In this embodiment the first light output is effectively combined with the second light output.

The reflector may comprise an array of apertures. The array of apertures may be a regular array of apertures. The apertures may comprise a regular geometrical shape e.g. they may be circular.

The reflector may comprise a transparent film and a plurality of patterned reflective or optical features. In this embodiment the reflector provides a means for controlling the proportion of light emitted within the first and second light outputs. It may also provide a means to further control the light beam profile and output angle of the first and second outputs.

Optionally the lighting panel further comprises a second LED mounted upon the second surface of the transparent substrate such that light emitted from second LED is guiding through the composite structure in a separate direction to that of the light emitted by the first LED. In this embodiment the configuration of the plurality of transparent prism structures acts to extract a third and a fourth light output from the lighting panel.

Preferably the light emitted from second LED is guiding through the composite structure in an opposite direction to that of the light emitted by the first LED.

The transparent substrate preferably has a refractive index nₛ between 1.50 and 1.66.

The transparent prism structures preferably have a refractive index nₚ between 1.46 and 1.58.

The transparent guide layer preferably has a refractive index n_{g} between 1.46 and 1.56.

The transparent coating layer preferably has a refractive index n_{c} between 1.37 and 1.58.

Most preferably the refractive indices of the transparent substrate and the transparent prism structures are selected such that they satisfy the inequality nₛ≧nₚ.

Most preferably the refractive indices of the transparent substrate and the transparent guide layer are selected such that they satisfy the inequality nₛ≧n_{g}.

Most preferably the refractive indices of the transparent prism structures and the transparent coating layer are selected such they satisfy the inequality nₚ≧n_{c}.

According to a second aspect of the present invention there is provided a method of producing a lighting panel the method comprising:
mounting a plurality of transparent prism structures onto a first surface of a transparent substrate;
mounting an LED onto a second surface of the transparent substrate and
adding a guide layer to the second surface so as to encapsulate the LED upon the second surface
configuring the mounted plurality of transparent prism structures so as to extract a first and a second light output from the lighting panel, the first and second light outputs having output angles and beam widths determined by the plurality of transparent prism structures.

Optionally the method of producing a lighting panel further comprises applying a transparent coating layer to the plurality of transparent prism structures wherein the transparent coating layer provides a further means for determining the output angles of the first and second light outputs.

Preferably the transparent coating is applied to the plurality of transparent prism structures so as to form a substantially planar surface.

Optionally the method of producing a lighting panel further comprises arranging a reflector so as to reflect the first light output back through the composite structure.

Optionally the method of producing a lighting panel further comprises mounting a second LED mounted upon the second surface of the transparent substrate such that light emitted from second LED is guiding through the composite structure in a separate direction to that of the light emitted by the first LED.

Preferably the second LED is mounted upon the second surface of the transparent substrate such that light emitted from the second LED is guiding through the composite structure in an opposite direction to that of the light emitted by the first LED.

Embodiments of the second aspect of the invention may comprise features to implement the preferred or optional features of the first aspect of the invention or vice versa.

### BRIEF DESCRIPTION OF DRAWINGS

Aspects and advantages of the present invention will become apparent upon reading the following detailed description and upon reference to the following drawings in which:

FIG. 1 presents a schematic representation of an LED spot light system as known in the art;

FIG. 2 presents a side vie o an LED based lighting panel as known in the art;

FIG. 3 presents a side view of a lighting panel in accordance with an embodiment of the present invention;

FIG. 4 presents a beam profile measurement for the lighting panel of FIG. 3.

FIG. 5 presents
(a) a side view of the lighting panel of FIG. 3 incorporating a reflective layer on the side of the prisms structures; and
(b) a top view of an alternative embodiment of the re lector;

FIG. 6 presents a side view of a lighting panel in accordance with an alternative embodiment of the present invention;

FIG. 7 presents a representation of the light output of the lighting panel of FIG. 6;

FIG. 8 presents
(a) a side view of the lighting panel of FIG. 3 incorporating a coating on the prisms;
(b) A Lop view of an alternative embodiment of the coating;

FIG. 9 presents a beam profile measurement taken from the lighting panels presented in FIG. 3 and FIG. 8; and

FIG. 10 presents a top view of a lighting panel in accordance with an alternative embodiment of the present invention.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION

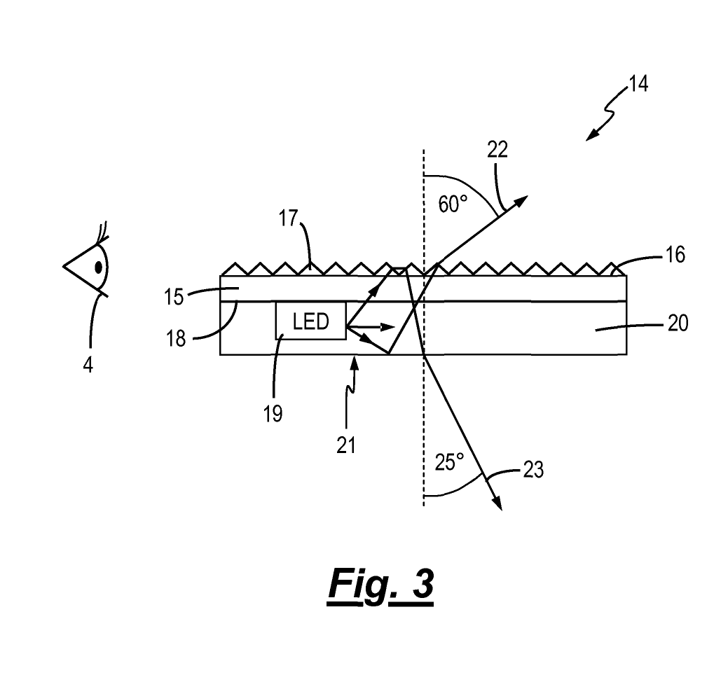

Referring initially to FIG. 3, a side view of a lighting panel 14 in accordance with an embodiment of the present invention is shown. The lighting panel 14 can be seen to comprise a substrate 15 made from a transparent polymer sheet, such as polyester or polycarbonate, and having a refractive index nₛbetween 1.50 and 1.66.

Located on a first surface 16 of the transparent substrate 15, is an array of 90° prism structures 17, also formed from a transparent plastic polymer and having a refractive index nₚ between 1.46 and 1.58. The refractive indices of the transparent substrate 15 and the transparent prism structures 17 are selected such that they satisfy the inequality nₛ≧nₚ.

The substrate 15 and the prism structures 17 can be provided as a single commercial product, a Vikuiti™ brightness enhancement film (BEF III) being an example of such a product employed within the presently described embodiment. In this product the substrate has a thickness of approximately 127 microns while the prism structures 17 have a thickness of approximately 28 microns. The refractive index n, of the substrate 15 is selected to be 1.61 while the refractive index nₚ of the prism structures 17 is chosen to be 1.58.

Located on a second surface 18 of the substrate 15, the second surface 18 being opposite the first surface 16, is a side emitting LED 19 whose output has a lambertian distribution (120° full width half maximum), a Nichia® 206 LED being an example of a suitable LED device. Electrical tracking (not shown in FIG. 3) is located on the second surface 18 of the substrate 15, and provides a means for supplying electrical power to the LED 19, as and when appropriate. The LEDs may be bonded to the tracks on the second surface 18 of the substrate 15 in a standard manner known to those in the art.

Covering the LED 19 and the remaining area of the second surface 18 of the substrate 15 is a guide layer 20, also formed from a transparent plastic polymer, and having a refractive index n_{g} between 1.46 and 1.56. The refractive indices of the transparent substrate 15 and the transparent guide layer 20 are selected such that they satisfy the inequality nₛ≧n_{g}. In order to satisfy this inequality the presently described embodiment employs a transparent guide layer 20 having a refractive index n_{g} of 1.51.

As a result of the above arrangement and choice of the refractive indices n_{g}, nₛ and nₚ light 21 generated by the LED 19 is initially coupled into the transparent guide layer 20, so as to propagate in a direction substantially parallel to a plane defined by the transparent substrate 15, as shown on FIG. 3. The light is however permitted to propagate into the transparent substrate 15 and the prism structures 17, as is also shown in FIG. 3.

When the light 21 interacts with the transparent prism structures 17, this acts to disrupt or overcome the effects of total internal reflection within the combined structure formed from between the transparent guide layer 20 and the transparent substrate 15. As a result, the light 21 is redirected so as to exit the lighting panel 14 via the transparent prism structures 17, as a first light output as depicted by reference numeral 22, or via the transparent guide layer 20, after propagating back through the transparent substrate 15 and the transparent guide layer 20, as a second light output as depicted by reference numeral 23.

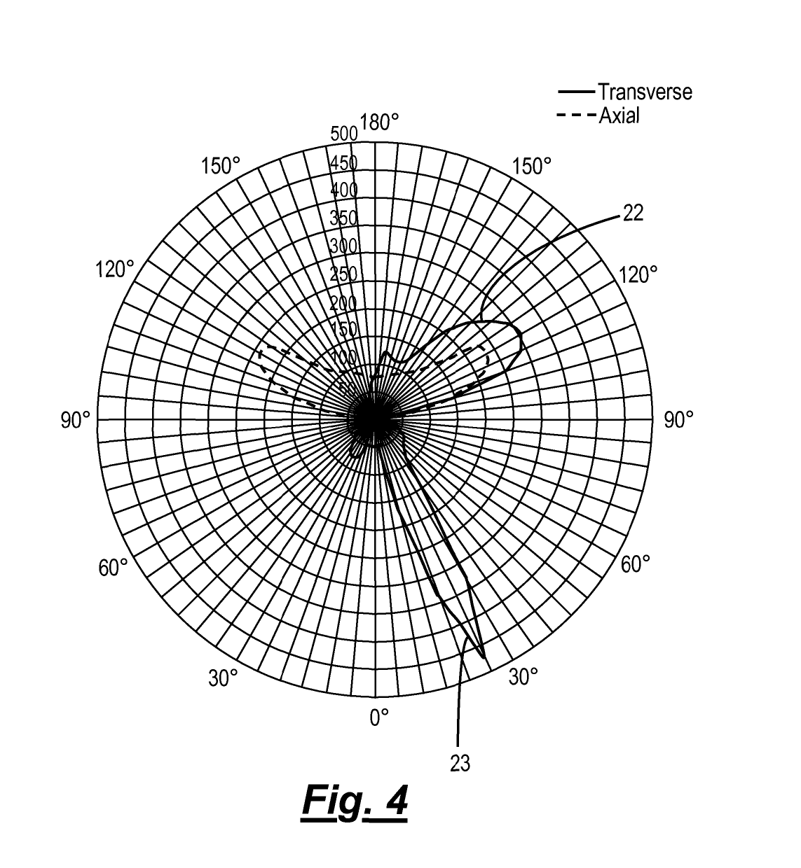

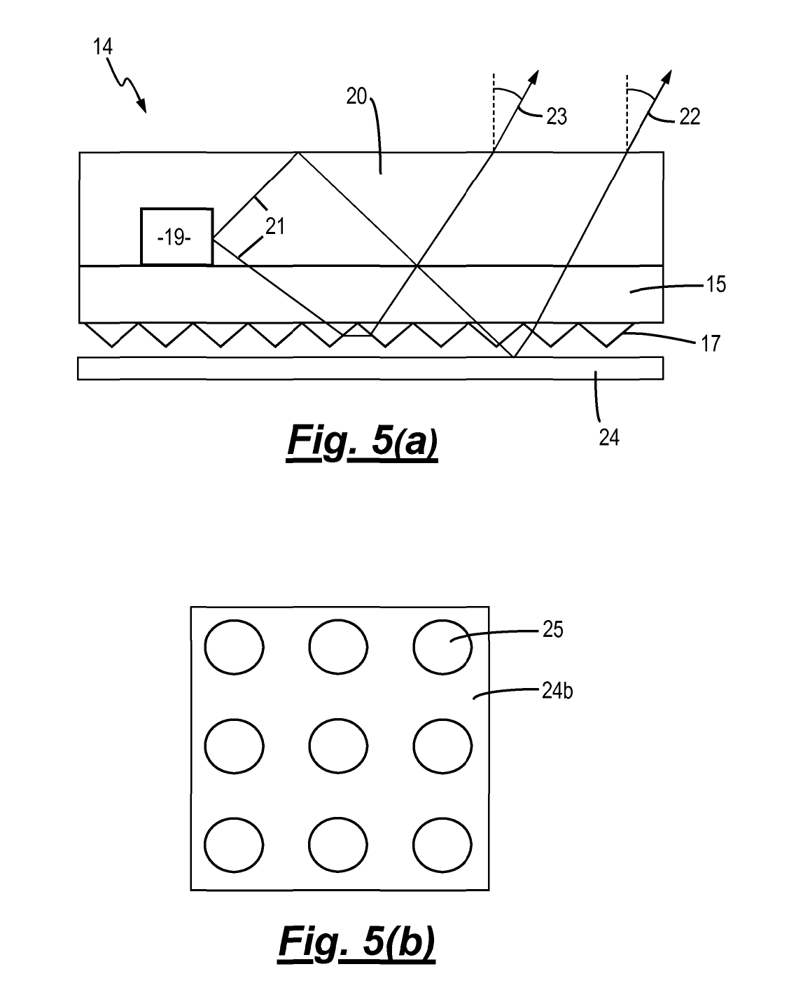

It is the form of the prism structures that determines the output angles and beam widths of the first 22 and second 23 light outputs. Indeed the presence of the prism structures 17 act to increase the on-axis brightness of the first 22 and second 23 light output beams by compressing the light into a narrower viewing angle. This compression of the light output beams 22 and 23 can clearly be seen within the transverse beam profile measurement (solid line) for the lighting panel 14 presented in FIG. 4. As can be seen, the first light output beam 22 has a beam distribution which peaks at approximately 60° from a normal to the transparent substrate 15, has a full width half maximum of 30° and contains approximately 40% of the light exiting the device 14. By comparison, the second light output beam 23 has its peak at 25° from a normal to the exterior surface of the guide layer 20, exhibits a full width half maximum of 10° and contains approximately 60% of the light exiting the device.

FIG. 4 also presents an axial beam profile measurement (dashed line) of the light output beams 22 and 23 i.e. this is the view of the light output beams 22 and 23 as seen by the observer 4.

FIG. 5(a) presents a side view of the lighting panel 14 of FIG. 3, which now incorporates a reflector 24 located such that the transparent prism structures 17 lie between the reflective layer 24 and the transparent substrate 15. The reflector may comprise a specular or non-specular reflective material. The inclusion of the reflector 24 acts to reflect the first light output 22 from the lighting panel 14 back through the device via the prism structures 17, such that this light 22 then contributes to the previously described second light output 23.

It will be appreciated by those skilled in the art that the reflector 24 could be orientated on the opposite side of the lighting panel 14, to its position shown in FIG. 5a. In this embodiment, the reflector 24 acts to reflect the second light 23 output from the lighting panel 14, such that it passes back through the device, and then exits the device through the prism structures 17, so as to contribute to the previously described first light output 22.

A top view of an alternative reflector 24b is presented in FIG. 5(b). The reflector 24b can be seen to comprise a 3×3 regular array of circular apertures 25 located across its surface area. The inclusion of these apertures provides a means for varying the proportion of light present within the light output beams 22 and 23 and on what side of the device they will be emitted. It will be appreciated by the skilled reader that the number, shape and alignment of the apertures can be altered. It is the combination of the size, number and relative arrangement of the apertures 25 which determine the proportion of light delivered outside the system on each side.

In a further alternative embodiment the reflector 24 or 24b may comprise a transparent film with patterned reflective or optical features to control the proportion of light or further control the light beam profile and angle. In particular, locating the features on or around the LED positions can provide a means for reducing the glare or so-called “sparkle” as viewed by an observer.

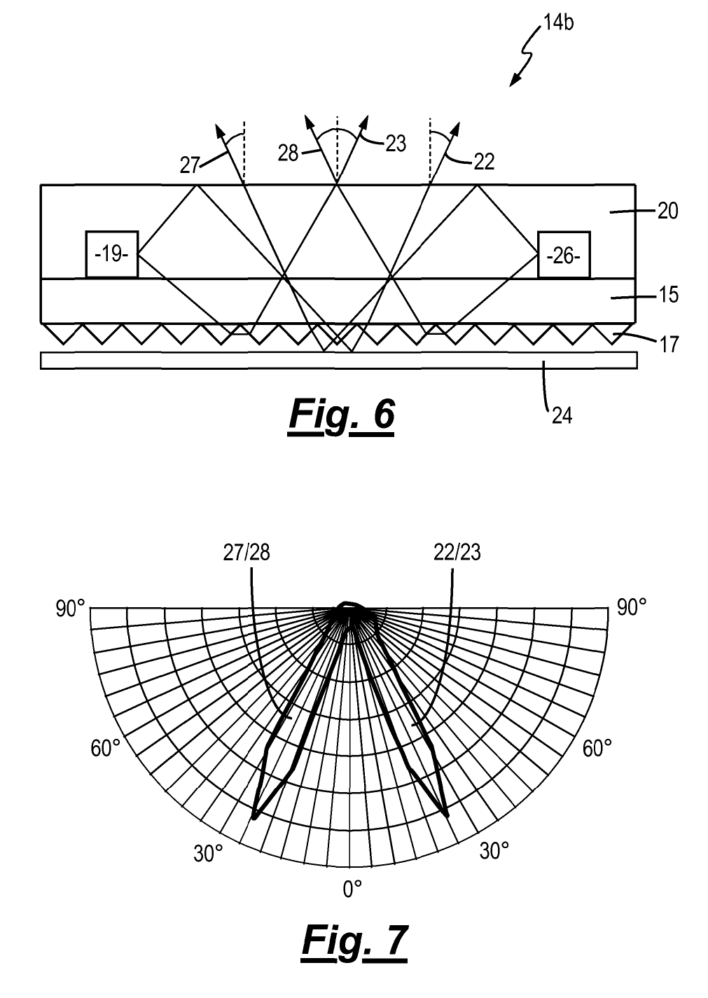

A further alternative embodiment of the lighting panel 14b is presented in FIG. 6. This embodiment is similar to that presented in FIG. 5, however, instead of an LED 19 being located so as to propagate light in a single direction, a second LED 26 is located on the first surface 16 of the substrate 15, such that light now propagates in both directions through the lighting panel 14b. In this embodiment, instead of a just the light output 23 being generated by the lighting panel 14b, additional light outputs 27 and 28 are now present centred around −25° from the normal two light guide layer 20, and again exhibiting a full width half maximum of approximately 10°.

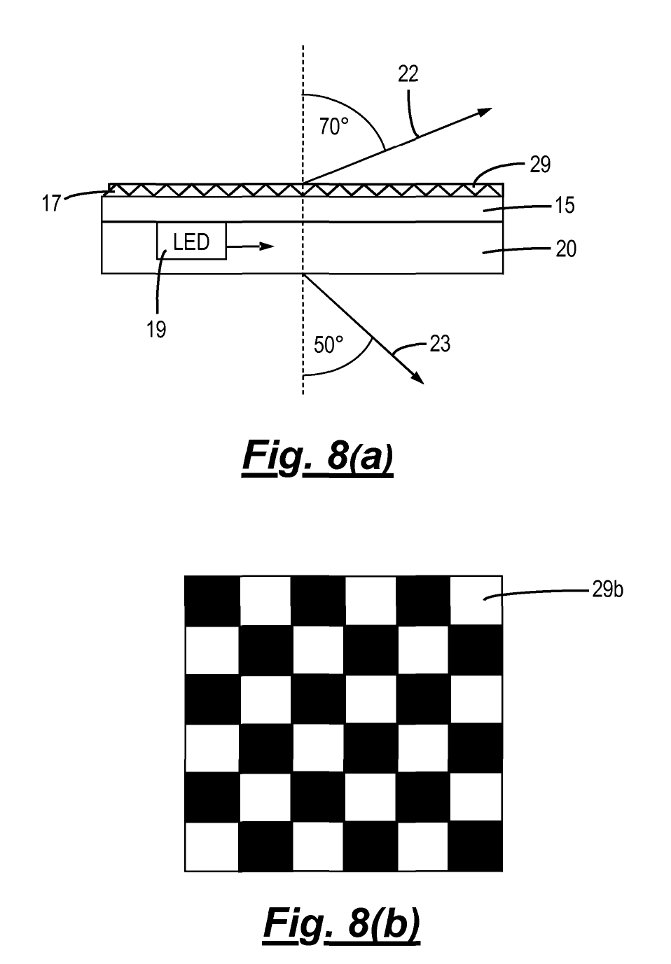

Further detail of the light output from the lighting panel 14b of FIG. 6 is presented in FIG. 7. As can be clearly seen, this figure shows that with LEDs directing light in both directions, the light exiting system has two peaks 23 and 27. This configuration is particularly useful for producing so-called “bat wing” distributions as is commonly required in luminaries for professional lighting applications.

The ability to further control the output beam angle of the light outputs 22, 23 and 27 from the lighting panels 10 and 14b will now be described with reference to FIG. 8. In particular FIG. 8(a) presents a lighting panel 14c similar to that presented in FIG. 3, however in the presently described embodiment, a transparent coating layer 29 has been applied to the external surface of the transparent prism structures 17. The coating layer 29 is again made from a transparent polymer, such as silicone, polyurethane or acrylic and has a refractive index n_{c} between 1.37 and 1.47. The refractive indices of the transparent prism structures 17 and the transparent coating layer 29 are selected such they satisfy the inequality nₚ≧n_{c}. As a result, and as shown in FIG. 8(a), light 21 generated by the LED 19 can propagate through the lighting panel 14c and into the coating layer 29. In the presently described embodiment the refractive index of the coating layer 29 is selected to be 1.42.

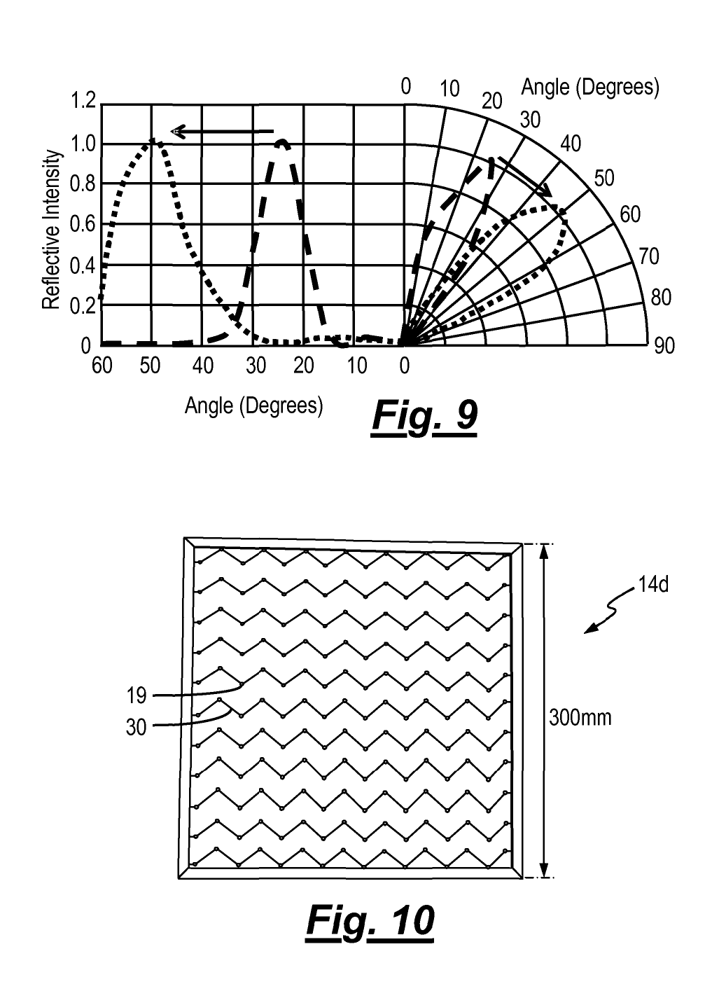

As a result of the introduction of the coating layer 29, the beam angle of the first light output 22 from the lighting panel 14c is increased from 60° to 70° while that of the second light output 23 is increased from 25° to 50°. This effect is further illustrated by the beam profile measurement profile presented in FIG. 9, which shows the comparison of the second light output 23 from the lighting panel 14 and 14c presented in FIGS. 3 and 8. As can clearly be seen, the peak in the angle of distribution from the second light output 23 increases from 25° to 50°, as a result of the inclusion of the coating layer 29.

It is preferable that the coating layer 29 is added to the prism structures 17, so as to form a substantially planar surface. As a result, the second light output 23 is refracted by the combination of the prism structures 17 and the coating layer 29, and not just the coating layer 29 as may be expected to the non-informed observer. A further advantage of employing the coating layer 29 to form a substantially planar surface, is that such a surface is less likely to collect dirt or dust when compared to that of the prism structures 17 in isolation.

As will be appreciated by the skilled reader, the refractive index of the coating layer 29 can be selected so as to achieve the desired output angles for the beams 22 and 23, and may of course be employed in conjunction with the reflective layer 24, as previously discussed with reference to FIG. 6. In practice, it is found that patterning of the coating layer 29 or controlling its depth can provide further control to the output angles for the beams 22 and 23. An example of such a patterned transparent coating layer 29b is presented in FIG. 8(b). The spatially pattern is a chequered square pattern which acts to providing two components to both the first 22 and second 23 output beams. The resulting light intensity distribution is therefore a superposition of these two components of the first 22 and second 23 output beams, thus providing a further method for determining the final profile and angle of the light beams. It will be appreciated by the skilled reader that other regular and irregular patters may be adopted by the patterned transparent coating layer 29b e.g. lines or stripes.

In order to demonstrate the scalability of this device FIG. 10 presents a top view of a commercial lighting panel 14d in accordance with an alternative embodiment of the present invention. The lighting panel 14d is based on a 300 mm square section of a Vikuiti™ brightness enhancement film (BEF III) which performs the function of the transparent substrate 15 and the transparent prism structures 17. Located on the second surface 18 of the substrate 15 are one hundred and seventy six Nichia® 206 LEDs 19. Electrical tracking 30 is located on the second surface 18 of the substrate 15, and provides a means for supplying electrical power to the LED 19, as and when appropriate. The guide layer 20 again encapsulates the LEDs 19 on the second surface 18. The lighting panel 14d has an overall thickness of around 2 mm.

The above described embodiments provide lighting panels 14, 14b, 14c and 14d that produce narrowed beam angular distributions from wide angle (lambertian) LED sources. This is achieved by the employment of the transparent layer of prism structures 17.

Furthermore, by embedding the LEDs 19 and 26 within the devices 14, 14b, 14c and 14d also provides the added advantage of significantly improving the optical coupling of the light 21 into the guide layer 20. This configuration also allows for the LEDs 19 and 26 to be located anywhere across the first surface 16 of the transparent substrate 15 thus providing a means for significantly reducing the average optical path length of the light 21. The combination of both of these features results in systems that exhibit high optical efficiencies when compared to the lighting panel systems known in the art.

The described structures also have the further advantage in that they enable the use of more stable transparent optical polymers in the vicinity of the LEDs 19 and 26. They also act to distribute the thermal dissipation evenly over the entire area of lighting panels 14, 14b, 14c and 14d, rather than just at the edges as found within the edge coupled prior art systems, see FIG. 2. Both of these features act in combination to provide LED lighting panels 14, 14b, 14c and 14d which exhibits significantly longer operating lifetimes than those known in the art.

The above embodiments have all been described with reference to the employment of 90° prism 1-dimensional structures 17. It will however be appreciated by the skilled reader that other angled prism structures could equally well be employed. Different output beam profiles and angle widths can also be obtained by employing different shaped prism structures, for example, lenses, micro-lenses, 2-dimensional prism pyramid structures or saw-tooth (asymmetric prisms), holographic and other diffractive or refractive structures. These can have a regular distribution or random distribution.

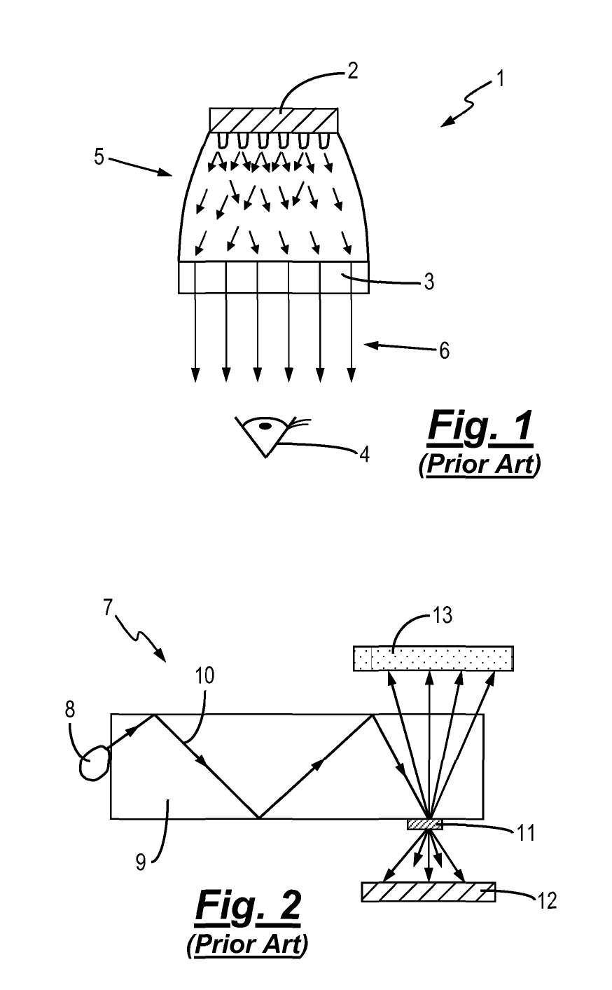

A further advantage of the above described lighting panels 14, 14b, 14c and 14d, is that narrow beam widths can be achieved from a wide beam angle light source 19 and 26 in a very thin device in a direction generally perpendicular or off-axis compared to the direction of the light emitted from the LED sources 19 and 26. The described lighting panels 14, 14b, 14c and 14d, have typical thicknesses of around 2 mm. This allows for thin lighting panels to have directed and focused light delivery without any additional external components, such as beam control films being required. This acts to significantly improve the optical efficiency, reduce system costs and ease of manufacture, integration and installation. By way of example, in room lighting, a panel deployed as a thin layer on the floor can produce a focused beam efficiency delivered up onto an adjacent wall. Previously, thick and bulky spotlight types of devices, as presented in FIG. 1, would be required to produce the required focused beam and required optical efficiency.

In addition, the described devices 14, 14b, 14c and 14d can be given added functionality by adding a coating layer 29 onto the light extraction surface features 17, which then function to modify the output beam angle of the output light 22, 23 and 27. This layer 29 is selected to have a lower refractive index than the surface extraction features 17, but higher than that of air and so acts to increase the angle of distribution from the normal direction. The benefit of this approach is that it gives an easy manufacturing control of the output beam angles for a fixed substrate surface feature in the light panel structure. This avoids the costly requirement of producing a new light extracting feature design (prisms with different angles) for each required product beam angle.

A lighting panel that provide an alternative means for producing a “spot light” like illumination from an LED is described. The lighting panel comprising a transparent substrate upon a first surface of which are mounted a plurality of transparent prism structures and upon a second surface of which is mounted a light emitting diode (LED). A transparent guide layer is arranged so as to encapsulate the light emitting diode upon the second surface such that the transparent base substrate and the transparent guide light form a composite structure for guiding light emitted from the LED. The transparent prism structures are configured to extract a first and a second light output from the lighting panel, the first and second light outputs having output angles and beam widths determined by the structure of the plurality of transparent prism structures. The lighting panels exhibit high optical efficiencies and long operating lifetimes.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A lighting panel comprising a transparent substrate upon a first surface of which are mounted a plurality of transparent prism structures and upon a second surface of which is mounted a light emitting diode (LED), and a transparent guide layer, the guide layer being arranged so as to encapsulate the LED upon the second surface such that the transparent base substrate and the transparent guide light form a composite structure for guiding light emitted from the LED, wherein the plurality of transparent prism structures are configured to extract a first and a second light output from the lighting panel, the first and second light outputs having output angles and beam widths determined by the plurality of transparent prism structures.

2. A lighting panel as claimed in claim 1 wherein the plurality of transparent prism structures extract the first and second light output from the lighting panel by disrupting internal reflection effects within the composite structure.

3. A lighting panel as claimed in claim 1 wherein the first and second light outputs are extracted from opposite sides of the lighting panel.

4. A lighting panel as claimed in claim 1 wherein the plurality of transparent prism structures are configured to compress the light emitted from the LED.

5. A lighting panel as claimed in claim 1 wherein the lighting panel further comprise a transparent coating layer applied to the plurality of transparent prism structures wherein the transparent coating layer provides a further means for determining the output angles of the first and second light outputs.

6. A lighting panel as claimed in claim 5 wherein the transparent coating is applied to the plurality of transparent prism structures so as to form a substantially planar surface.

7. A lighting panel as claimed in claim 5 wherein the transparent coating layer comprises a spatial pattern

8. A lighting panel as claimed in claim 1 wherein the lighting panel further comprises a reflector arranged so as to reflect the first light output back through the composite structure.

9. A lighting panel as claimed in claim 8 wherein the reflector comprises an array of apertures.

10. A lighting panel as claimed in claim 9 wherein the array of apertures comprises a regular array of apertures.

11. A lighting panel as claimed in claim 9 wherein the apertures comprise a regular geometrical shape.

12. A lighting panel as claimed in claim 8 wherein the reflector comprises a transparent film and a plurality of patterned reflective or optical features.

13. A lighting panel as claimed in claim 1 wherein the lighting panel further comprises a second LED mounted upon the second surface of the transparent substrate such that light emitted from second LED is guiding through the composite structure in a separate direction to that of the light emitted by the first LED.

14. A lighting panel as claimed in claim 13 wherein the light emitted from second LED is guiding through the composite structure in an opposite direction to that of the light emitted by the first LED.

15. (canceled)

16. (canceled)

17. (canceled)

18. (canceled)

19. A lighting panel as claimed in claim 1 wherein a refractive index of the transparent substrate (nₛ) and a refractive index of the transparent prism structures (nₚ) are selected such that they satisfy the inequality nₛ≧nₚ.

20. A lighting panel as claimed in claim 1 wherein a refractive index of the transparent substrate (nₛ) and a refractive index of the transparent guide layer (n_{g}) are selected such that they satisfy the inequality nₛ≧n_{g}.

21. A lighting panel as claimed in claim 1 wherein a refractive index of the transparent prism structures (nₚ) and a refractive index of the transparent coating layer (n_{c}) are selected such they satisfy the inequality nₚ≧n_{c}.

22. A method of producing a lighting panel the method comprising:
mounting a plurality of transparent prism structures onto a first surface of a transparent substrate;
mounting an LED onto a second surface of the transparent substrate and adding a guide layer to the second surface so as to encapsulate the LED upon the second surface
configuring the mounted plurality of transparent prism structures so as to extract a first and a second light output from the lighting panel, the first and second light outputs having output angles and beam widths determined by the plurality of transparent prism structures.

23. A method of producing a lighting panel as claimed in claim 22 wherein the method further comprises applying a transparent coating layer to the plurality of transparent prism structures wherein the transparent coating layer provides a further means for determining the output angles of the first and second light outputs.

24. A method of producing a lighting panel as claimed in claim 23 wherein the transparent coating is applied to the plurality of transparent prism structures so as to form a substantially planar surface.

25. A method of producing a lighting panel as claimed in claim 22 wherein the method further comprises arranging a reflector so as to reflect the first light output back through the composite structure.

26. A method of producing a lighting panel as claimed in claim 22 wherein the method further comprises mounting a second LED mounted upon the second surface of the transparent substrate such that light emitted from second LED is guiding through the composite structure in a separate direction to that of the light emitted by the first LED.

27. A method of producing a lighting panel as claimed in claim 26 wherein the second LED is mounted upon the second surface of the transparent substrate such that light emitted from the second LED is guiding through the composite structure in an opposite direction to that of the light emitted by the first LED.
